(19) United States
(12) Patent Application Publication
(10) Pub. No.: US 2026/0330959 A1
(43) Pub. Date: Oct. 22, 2026

(54) Fire Detector With An Alarm Indication In The Case Of Contamination

(71) Applicant: Siemens Schweiz AG, Zürich (CH)

(72) Inventors: Mathias Staeger, Zug (CH); Thomas Bachels, Zug (CH)

(73) Assignee: Siemens Schweiz AG, Zürich (CH)

(21) Appl. No.: 19/648,678

(22) Filed: Apr. 15, 2026

(30) Foreign Application Priority Data
Apr. 17, 2025 (EP) 25171272.5

(51) Int. Cl. G08B 29/14; G08B 17/107

(52) U.S. Cl. CPC G08B 29/145; G08B 17/107

(57) ABSTRACT

An example fire detector includes: a housing with an inlet opening; a protective grid; a sensor system; and a control unit to generate an alarm indication in event of contamination. The sensor system has a heating element and a temperature sensor. The protective grid is between the heating element and the temperature sensor. The control unit repeatedly actuates the heating element and senses amplitude of rise in temperature and generates an alarm if, within a specified test period, the amplitude remains below a specified comparison amplitude and/or an amplitude rise time in the temperature and generate an alarm indication if, the amplitude rise time is greater than a specified rise time of a comparison amplitude, and/or ascertains a time integral of the rise in temperature in the temperature signal and generate an alarm indication if, the value of the ascertained integral remains below a specified comparison integral value.

### CROSS-REFERENCE TO RELATED APPLICATIONS

This application claims priority to EP Application No. 25171272.5 filed Apr. 17, 2025, the contents of which are hereby incorporated by reference in their entirety.

### TECHNICAL FIELD

The present disclosure relates to fire detectors. Various embodiments of the teachings herein include fire detectors generating a fire alarm if they detect contamination.

### BACKGROUND

A fire detector can be a smoke detector, a temperature or heat detector, or a combination thereof. A smoke detector has a detection unit for detecting smoke particles, in particular an optical detection unit operating according to the scattered light principle. A smoke detector can comprise a detection unit using the acousto-optic principle or an optical detection unit using the optical beam principle. The fire detector can also have one or more gas sensor(s) for detecting typical fire-related gases. The fire detectors have a signal and/or data connection to a central fire alarm system a shared detector line, in particular via a two-wire line. A plurality of such fire detectors can be connected in detector groups or detector lines to a central fire alarm system.

To guarantee the reliable operation of a fire detector the protective grid, which can also be a mesh, should not be blocked in the region of the inlet openings of a fire detector, for example by dust or insects, or are not sealed or covered, for example by means of adhesive tape or a protective cap. One possibility for ensuring this are regular on-site visual inspections.

From EP 503 167 A1 and EP 3 073 458 A1 it is known to determine the patency of a protective grid according to the optical beam or scattered light principle.

From EP 1 768 074 A1 a method and a smoke detector are described for detecting a fire and for generating a fire alarm. A further sensor unit, for example a temperature sensor unit, monitors a further fire characteristic for the earliest possible fire detection. It is disclosed, inter alia, that for a short time, for example for 1 second, an NTC as a temperature sensor unit is heated by applying current/voltage and that thereafter the air velocity is inferred by way of the change in the resistance in the cooling phase. Since some fires induce a strong air flow, even before smoke particles have reached the detector in sufficient quantity, it is possible to detect an early development of a possible fire by way of the measurement of the flow speed.

From EP 2 624 229 A1 a smoke detector comprises a housing with a measuring chamber for detecting smoke particles. The smoke detector has a flow sensor for detecting a flow as a measured variable for evaluating the operational capability of the smoke detector, and a suitable evaluation facility based thereon. In a constructive embodiment which is preferred there, the flow sensor is embodied as a hot wire flow sensor whose functional principle is based on the fact that a hot wire cools owing to the flow. The degree of cooling is a function of the flow velocity and the air temperature.

EP 2 270 762 A2 proposes a 2-chamber system in the interior of a smoke detector, in which a fan in the interior of the smoke detector ensures that air flows into and out of the chamber. A sensor element is provided with which the strength of a secondary air flow can be measured, and this depends on the degree of contamination of the smoke inlet opening and of the protective grid. Inter alia, a temperature-dependent resistor with negative temperature coefficient (NTC) is proposed as a sensor element. According to one embodiment therein, either the air flow or the sensor element itself is heated and the flow velocity is inferred from the measured temperature profile on cooling. A waiting time can be inserted between heating and measuring.

### SUMMARY

Some embodiments of the teachings herein include a fire detector for detecting at least one fire characteristic as well as for outputting a fire alarm (AL) in a detected case of fire, wherein the fire detector (M) is configured for the electrical supply of the fire detector (M) with an electrical power via a detector line (ML) of a fire detection system, wherein the fire detector (M) has a housing (G) with at least one inlet opening (OF), wherein a penetrable protective grid (N) is arranged in the region of the at least one inlet opening (OF), wherein arranged in the region of at least one of the inlet openings (OF) is a sensor system for detecting contamination present there, wherein the fire detector (M) comprises a control unit (MC) communicatively connected to the sensor system, and wherein the control unit (MC) is configured to output an alarm indication (WM) in the event of detected, impermissibly high contamination, wherein the sensor system has at least one heating element (H1-H4), which can be actuated by the control unit (MC), as well as a temperature sensor (T1-T4), associated with the respective heating element (H1-H4) and connected to the control unit (MC), for outputting a temperature sensor signal (S1-S4), wherein the protective grid (N) is arranged between the respective heating element (H1-H4) and the associated temperature sensor (T1-T4) respectively, wherein when the fire detector (M) is mounted as intended on the ceiling, the temperature sensor (T1-T4) associated with a respective heating element (H1-H4) is arranged in the thermal convection path of the respective heating element (H1-H4), wherein the fire detector (M) has an electrical energy store (C) for buffering electrical power provided via the detector line (ML), wherein the control unit (MC) is configured to repeatedly actuate the respective heating element (H1-H4) with a specifiable heating duration (HD) for short-term emission of a predetermined quantity of heat Q if a sufficiently large, buffered quantity of electrical energy is loaded in the energy store (C), and wherein, coordinated therewith, the control unit (MC) is configured to repeatedly detect an amplitude of a rise in temperature (dA) in the temperature sensor signal (S1-S4) of the respectively associated temperature sensor (T1-T4) and to output an alarm indication (WM) if, within a specified test period (PD) from emission of the predetermined quantity of heat Q, at least one of the amplitudes of a rise in temperature (dA) remains below a specified comparison amplitude of a rise in temperature (dAMIN), and/or detect an amplitude rise time (dT) in the temperature sensor signal (S1-S4) of the respectively associated temperature sensor (T1-T4) and output an alarm indication (WM) if, within a specified test period (PD) from emission of the predetermined quantity of heat Q, at least one of the amplitude rise times dT is greater than a specified rise time of a comparison amplitude (dTMAX), and/or ascertain a time integral of the rise in temperature in the temperature signal (S1-S4) of the respectively associated temperature sensor (T1-T4) and output an alarm indication (WM) if, within a specified test period (PD) from emission of the quantity of heat Q, the value of the ascertained integral remains below a specified comparison integral value.

In some embodiments, the control unit (MC) is configured to actuate the respective heating element (H1-H4) to emit a quantity of heat Q in the range of 10 mJ to 5 Joules, in particular of 20 mJ to 3 Joules, of 20 mJ to 1 Joule, with a heating duration (HD) in the range of 1 second to 30 seconds, of 1 second to 10 seconds, or of 1 second to 3 seconds.

In some embodiments, the respective heating element (H1-H4) and/or the respective temperature sensor (S1-S4) has a thermal time constant Tₜₕₑᵣₘ in the range of 0.5 to 10 seconds, of 0.5 to 6 seconds, or of 0.5 to 4 seconds.

In some embodiments, an amplitude of a rise in temperature (dAU) in the uncontaminated state of the fire detector (M) lies in the range of 20 mK to 1,000 mK, in the range of 20 mK to 200 mK, or in the range of 30 mK to 100 mK, or the specified comparison amplitude of a rise in temperature (dAMIN) lies in the range of 0.1 to 0.8 times, of 0.25 to 0.75 times, the amplitude of a rise in temperature (dAU).

In some embodiments, the specified rise time of a comparison amplitude (dTMAX) has a value in a range of 5 seconds to 25 seconds, of 5 seconds to 20 seconds, or of 7 seconds to 15 seconds, or the specified rise time of a comparison amplitude (dTMAX) has a value which lies in a range of 1.2 to 3 times, or of 1.5 to 2.5 times, an amplitude rise time (dTU) in the uncontaminated state of the fire detector (M).

In some embodiments, the control unit (MC) for detecting a significant rise in temperature is configured to ascertain the time integral of the rise in temperature in the temperature signal (S1-S4) of the respectively associated temperature sensor (T1-T4), wherein the specified comparison integral value lies in a range of 0.1 to 0.8 times, or of 0.25 to 0.8 times, the time integral value in the uncontaminated state of the fire detector (M).

In some embodiments, the respective amplitude of a rise in temperature (dA), the respective amplitude rise time (dT) and/or the respective time integral value is computationally formed from a sliding mean of a plurality of respectively repeatedly (TZ) detected amplitudes of a rise in temperature (dA1-dA6), amplitude rise times (dT) or time integral values.

In some embodiments, the fire detector (M) has a constructive main axis (A), in particular an axis of symmetry, wherein the fire detector (M) has a fixing surface (BF) for at least detachable fixing of the fire detector (M) to an assembly plane (D), in particular to a ceiling, wherein the at least one inlet opening (OF) radially spaced part in relation to the main axis (A) and, in particular, uniformly in the circumferential direction in relation to the main axis (A), wherein the protective grid (N) is arranged in the region of the respective inlet opening (OF), wherein the at least one heating element (H1-H4) is arranged radially internally in relation to the protective grid (N) and wherein the respective associated temperature sensor (T1-T4) located in the thermal convection path is arranged radially externally in relation to the protective grid (N) and to the associated heating element (H1-H4).

In some embodiments, the control unit (MC) is configured to detect an amplitude rise time (dT′) in the temperature sensor signal (S1-S4) of the respectively associated temperature sensor (T1-T4), a respective associated amplitude of a rise in temperature (dA′) and a respective associated amplitude of a test rise in temperature (dAC′) after expiry of a specified covered test time (CP) from the instant of the detected amplitude rise time (dT′), re-detect, at least on the next repetition, an amplitude rise time (dT″) in the temperature sensor signal (S1-S4), re-detect a respective associated amplitude of a rise in temperature (dA″) and re-detect a respective associated amplitude of a test rise in temperature (dAC″) after expiry of the covered test time (CP) from the instant of the re-detected amplitude rise time (dT″), and output an alarm indication (WM) and/or a covered indication (WCOV) if the difference in the detected amplitude of a rise in temperature (dA′) and the detected amplitude of a test rise in temperature (dAC′) is at least 1.05 times, at least 1.1 times and or at least 1.2 times, as large as the difference in the re-detected amplitude of a rise in temperature (dA″) and the re-detected amplitude of a test rise in temperature (dAC″).

In some embodiments, the covered test time (CP) has a value in a range of 1 second to 30 seconds, of 3 seconds to 20 seconds, or of 3 seconds to 10 seconds.

In some embodiments, the fire detector (M) has a constructive main axis (A), in particular an axis of symmetry, wherein the fire detector (M) has a fixing surface (BF) for at least detachable fixing of the fire detector (M) to an assembly plane (D), in particular to a ceiling, wherein the at least one inlet opening (OF) is radially spaced part in relation to the main axis (A) and, in particular, uniformly in the circumferential direction in relation to the main axis (A), wherein the protective grid (N) is arranged in the region of the respective inlet opening (OF), wherein the at least one heating element (H1-H4) is arranged radially externally in relation to the protective grid (N), and wherein the respective associated temperature sensor (T1-T4) located in the thermal convection path is arranged radially internally in relation to the protective grid (N) and in relation to the associated heating element (H1-H4).

In some embodiments, the fire detector (M) has a constructive main axis (A), in particular an axis of symmetry, wherein the fire detector (M) has a fixing surface (BF) for at least detachable fixing of the fire detector (M) to an assembly plane (D), in particular to a ceiling, wherein a, in particular, central opening (ZO) is arranged at an outer side, which is axially opposite in relation to the main axis (A) of the fixing surface (BF), of a basic body (GG) of the housing (G), wherein the, in particular, central opening (ZO) has the protective grid (N), wherein the at least one heating element (H1-H4) is spaced further apart axially in relation to the fixing surface (BF) than the respectively associated temperature sensor (T1-T4) located in the thermal convection path, and wherein the protective grid (N) is arranged between the at least one heating element (H1-H4) and the respective temperature sensor (T1-T4).

In some embodiments, the fire detector (M) has a detector hood (GH) as part of the housing (G), which opposes the, in particular, central opening (ZO), wherein, in relation to the main axis (A), the, in particular, central opening (ZO) extends outwardly in the radial direction between the basic body (GK) and the detector hood (GH) and forms the at least one inlet opening (OF) there at a radial outer circumference of the housing (G).

In some embodiments, arranged in the interior of the housing (G) is an optical measuring chamber (MK) according to the scattered light or extinction principle and/or a gas sensor (GS) for detecting the at least one fire characteristic, wherein the control unit (MC) is configured to detect the respective detected temperature sensor signal (S1-S4) as a further fire characteristic, to evaluate a respective fire sensor signal, output by the optical measuring chamber (MK) and/or by the gas sensor (GS), together with the respective temperature sensor signal (S1-S4) and in the event of a then detected case of fire, to output the alarm (AL).

In some embodiments, the control unit (MC) is configured to repeatedly actuate the respective heating element (H1-H4) for emission of the predetermined quantity of heat Q, in particular cyclically with a measuring period (TZ), wherein the measuring period (TZ) lies in a range of 15 minutes to 1 month, in a range of 1 hour to 1 week, or in a range of 12 hours to 48 hours, and
the control unit (MC) is configured to repeatedly, in particular cyclically within the measuring periods (TZ), detect an amplitude of a rise in temperature (dA) in the temperature sensor signal (S1-S4) of the respectively associated temperature sensor (T1-T4) and output an alarm indication (WM) if, within the test period (PD), at least one of the amplitudes of a rise in temperature (dA) remains below the comparison amplitude of a rise in temperature (dAMIN), and/or detect an amplitude rise time (dT) in the temperature sensor signal (S1-S4) of the respectively associated temperature sensor (T1-T4) and output an alarm indication (WM) if, within the test period (PD), at least one of the amplitude rise times dT is greater than the rise time of a comparison amplitude (dTMAX), and/or ascertain a time integral of the rise in temperature in the temperature signal (S1-S4) of the respectively associated temperature sensor (T1-T4) and output an alarm indication (WM) if, within the test period (PD), the value of the ascertained integral remains below the comparison integral value.

### BRIEF DESCRIPTION OF THE DRAWINGS

Example embodiments of the teachings of the present disclosure are explained using the example of the following figures, in which:

FIG. 1 shows a sectional representation through an example fire detector incorporating teachings of the present disclosure with four heating elements and with four temperature sensors;

FIG. 2 shows an enlarged representation of a heating element/temperature sensor pair according to the example in FIG. 1;

FIG. 3 shows a plan view of the fire detector according to FIG. 1;

FIG. 4 shows the fire detector shown in FIG. 1 with a cover attached thereto;

FIG. 5 shows a sectional representation through an example fire detector incorporating teachings of the present disclosure with a vertical arrangement of two heating element/temperature sensor pairs;

FIG. 6 shows an example control unit incorporating teachings of the present disclosure for connection, inter alia, of four heating elements and four temperature sensors;

FIG. 7 shows different measured temperature profiles at a temperature sensor after emission of a quantity of heat and with different levels of contamination of a fire detector during a test; and

FIG. 8 shows a temperature profile at a temperature sensor with cyclical emission of a quantity of heat overlaid by an increasing ambient temperature.

### DETAILED DESCRIPTION

In some embodiments, the sensor system has at least one heating element which can be actuated by the control unit as well as a temperature sensor, associated with the respective heating element and connected to the control unit, for outputting a temperature sensor signal. The protective grid or mesh is arranged between the respective heating and the respectively associated temperature sensor. When the fire detector is mounted as intended on the ceiling, the temperature sensor associated with a respective heating element is arranged in the thermal convection path of the respective heating element. The fire detector also has an electrical energy store, in particular a capacitor, for buffering electrical power or energy provided via the detector line.

In some embodiments, the control unit is configured or programmed to repeatedly actuate the respective heating element with a specifiable heating duration for short-term emission of a predetermined quantity of heat Q if a sufficiently large, buffered quantity of electrical energy is loaded in the energy store. The control unit is configured to repeatedly or, coordinated therewith, to repeatedly detect an amplitude of a rise in temperature in the temperature sensor signal of the respectively associated temperature sensor and to output an alarm indication if, within a specified test period from emission of the predetermined quantity of heat Q, at least one of the amplitudes of a rise in temperature remains below a specified comparison amplitude of a rise in temperature. The control unit is, in particular, a processor-based control unit, preferably a microcontroller.

In some embodiments, the control unit can be configured to repeatedly or, coordinated therewith repeatedly, detect an amplitude rise time in the temperature sensor signal of the respectively associated temperature sensor and to output an alarm indication if, within a specified test period from emission of the predetermined quantity of heat Q, at least one of the amplitude rise times dT is greater than a specified rise time of a comparison amplitude.

In some embodiments, the control unit can be configured to repeatedly or, coordinated therewith, to repeatedly ascertain a time integral of the rise in temperature in the temperature signal of the respectively associated temperature sensor and to output an alarm indication, within a specified test period from emission of the quantity of heat Q, the value of the ascertained integral remains below a specified comparison integral value. As a result, reliable detection of impermissibly high contamination is possible particularly easily.

The control unit is configured to actuate the heating elements for emission of the predetermined quantity of heat, for example circularly and not simultaneously. As a result, only one of a plurality of inlet openings arranged in a distributed manner in the circumferential direction can advantageously be checked for penetrability with the total buffered electrical energy.

A contaminated protective grid or mesh influences the heat convection (convection) through the protective grid. In some embodiments, a heating element, for example in the form of a resistor, is arranged on the one side of the protective grid, and on the other side of the protective grid a temperature sensor, for example what is known as an NTC (for Negative Temperature Coefficient thermistor). An NTC is an example of a thermistor, that is to say for a temperature-dependent resistor, which is particularly suitable for temperature measurement. The more contaminated and thus less permeable a protective grid is, the smaller the fraction of the quantity of heat, emitted by the heating element, is which reaches the temperature sensor, and the slower the passage of the fraction of the quantity of heat through the protective grid is.

The protective grid is permeable for gases, in particular for fire gases such as carbon monoxide, carbon dioxide, ammonia or hydrogen. In contrast to the smoke detectors described in the introduction which depend on a self-generated air flow by means of a fan or on an existing air flow, such as in the form of turbulence in the space, convection is sufficient for detecting a contaminated protective grid.

In some embodiments, the test period for detecting a respective rise in temperature from the beginning of the heating duration is 60 seconds maximum, 30 seconds maximum, or 15 seconds maximum.

The fire detector is configured to also (only) draw a maximum electrical power with a value of 10 mW, with a value of 5 mW, or with a value of 3 mW, from the detector line.

In some embodiments, the heating element is an ohmic resistor, a Zener diode or what is known as a PTC (for Positive Temperature Coefficient thermistor). It may be an SMD element with low specific thermal capacity.

In some embodiments, the temperature sensor is a thermistor, in particular an NTC, such as a PT100 or PT1000. The maximum dimension of a heating element or a temperature sensor without taking into account connecting wires lies, in particular, at 5 mm, or at 3.5 mm.

In some embodiments, between the respective temperature sensor and the protective grid and/or between the respective heating element and the protective grid there is an air gap in the range of 1 mm to 10 mm, or in the range of 2 mm to 5 mm.

In some embodiments, the control unit is configured to actuate the respective heating element to emit a quantity of heat Q in the range of 10 mJ to 5 Joules, of 20 mJ to 3 Joules, or of 20 mJ to 1 Joules, with a comparatively short-term heating duration in the range of 1 second to 30 seconds, of 1 second to 10 seconds, or of 1 second to 3 seconds.

In some embodiments, the respective heating element and/or the respective temperature sensor has a thermal time constant Tₜₕₑᵣₘ in the range of 0.5 to 10 seconds, of 0.5 to 6 seconds, or of 0.5 to 4 seconds. In some embodiments, the respective heating element and the respective temperature sensor have an identical thermal time constant Tₜₕₑᵣₘ.

The thermal time constant is a measure of how quickly a system reacts to a change in the temperature. It indicates the time that a system requires in order to reach approximately 63%, that is to say around 1-1/e, of the difference between the initial temperature and the new equilibrium temperature. By way of the extremely fast emission of the electrical power introduced into the respective heating element, connected with a respective, extremely fast-reacting temperature sensor, it is possible to reliably detect a thermal surge passing through the protective grid and following the thermal convection path to the respective associated temperature sensor before the short-term thermal surge dissipates through the inlet opening into the surroundings around the fire detector.

In some embodiments, an amplitude of a rise in temperature in the uncontaminated state of the fire detector lies in the range of 20 mK to 1,000 mK, in the range of 20 mK to 200 mK, or in the range of 30 mK to 100 mK. In some embodiments, the specified comparison amplitude of a rise in temperature lies in the region of 0.1 to 0.8 times, or of 0.25 to 0.75 times, of the amplitude of a rise in temperature.

In particular, the specified rise time of a comparison amplitude in the uncontaminated state of the fire detector has a value in a range of 5 seconds to 25 seconds, of 5 seconds to 20 seconds, or of 7 seconds to 15 seconds. In some embodiments, the specified rise time of a comparison amplitude has a value which lies in a range of 1.2 to 3 times, or of 1.5 to 2.5 times, an amplitude rise time in the uncontaminated state of the fire detector.

In some embodiments, the control unit is configured to detect a significant rise in temperature, to ascertain the time integral of the rise in temperature in the temperature signal of the respectively associated temperature sensor, wherein the specified comparison integral value lies in a range of 0.1 to 0.8 times, or of 0.25 to 0.8 times, the time integral value in the uncontaminated state of the fire detector.

The comparison amplitude of a rise in temperature, the rise time of a comparison amplitude or the comparison integral value can be ascertained, for example, in a calibration phase or on initial operation of the fire detector since it can be assumed that the protective grid is not contaminated. The above-mentioned comparison values can be ascertained, for example, over several days or weeks.

In some embodiments, the respective amplitude of a rise in temperature is formed from a sliding mean of a plurality of respectively repeatedly detected amplitudes of a rise in temperature. In some embodiments, the respective amplitude rise time dT is formed from a sliding mean of a plurality of respectively repeatedly detected amplitude rise times dT. In some embodiments, the respective time integral value is computationally formed from a sliding mean of a plurality of respectively repeatedly detected time integral values. This may prevent an erroneous alarm indication being output due to a possible «outlier».

In some embodiments, the fire detector has a constructive main axis, in particular an axis of symmetry. The fire detector has a fixing surface for at least detachable fixing of the fire detector to an assembly plane, in particular to a ceiling. The at least one inlet opening is radially spaced apart in relation to the main axis and, in particular, uniformly in the circumferential direction in relation to the main axis. The protective grid is arranged in the region of the respective inlet opening, wherein the at least one heating element is arranged radially internally in relation to protective grid. The respective associated temperature sensor, located in the thermal convection path, is arranged radially externally in relation to protective grid and in relation to the associated heating element.

Typically, the constructive main axis runs centrally through the fire detector in the normal direction to the fixing surface of the fire detector. In many cases, fire detectors are embodied to be rotationally symmetrical or substantially rotationally symmetrical, with the fire detectors then being rotationally symmetrical in relation to this constructive main axis.

The radially external temperature sensor can also be used for fire detection within the meaning of a «temperature detector». Since the protective grid and the radially external temperature sensor are typically contaminated «together», the effect, accompanying the contamination, of a reduced amplitude of a rise in temperature together with an increasing amplitude rise time is intensified here «in the right direction».

In some embodiments, in relation to the fixing surface, the at least one heating element is spaced further apart axially from it than the respectively associated adjacent temperature sensor located in the thermal convection path. As a result, the temperature sensor is located in the thermally «upwardly» striving convection path of the ambient air heated directly by the adjacent heating element. As a result, improved detection of a rise in temperature is possible.

In some embodiments, the control unit is configured to detect an amplitude rise time in the temperature sensor signal of the respectively associated temperature sensor, a respective associated amplitude of a rise in temperature and a respective associated amplitude of a test rise in temperature after expiry of a specified covered test time from the instant of the detected amplitude rise time.

The control unit is also configured to re-detect, at least on the next repetition, an amplitude rise time in the temperature sensor signal, to re-detect a respective associated amplitude of a rise in temperature and to re-detect a respective associated amplitude of a test rise in temperature after expiry of the covered test time from the instant of the re-detected amplitude rise time.

The control unit is finally configured to then output an alarm indication and/or a covered indication if the difference in the detected amplitude of a rise in temperature and the detected amplitude of a test rise in temperature is at least 1.05 times, at least 1.1 times and or at least 1.2 times, as large as the difference in the re-detected amplitude of a rise in temperature and the re-detected amplitude of a test rise in temperature. As a result, it is possible to identify that the inlet openings are taped, for example by means of adhesive tape, or are covered, for example by means of a protective cap. This is based on the knowledge that due to the masking or covering of the inlet openings, it is not possible for a heat build-up or a heat cushion forming radially behind it in the direction of the respective temperature sensor to rapidly escape through the inlet opening. This is accompanied by delayed cooling of the ambient air which has built up there, and this in turn manifests itself metrologically at the temperature sensor there.

The first (time-wise) and the subsequently following second amplitude of a rise in temperature are simultaneously normalized relative to each other by the formation of differences, so it is possible to compare the two temperature profiles from the amplitude of a rise in temperature, i.e. the maximum temperature value in the rise in temperature.

In some embodiments, the covered test time has a value in a range of 1 second to 30 seconds, of 3 seconds to 20 seconds, or of 3 seconds to 10 seconds.

In some embodiments, the fire detector has a constructive main axis, in particular an axis of symmetry. The fire detector has a fixing surface for at least detachable fixing of the fire detector to an assembly plane, in particular to a ceiling. The at least one inlet opening is radially spaced apart in relation to the main axis and, in particular, uniformly in the circumferential direction in relation to the main axis. The protective grid is arranged in the region of the respective inlet opening. The at least one heating element is arranged radially externally in relation to the protective grid. In addition, the respective associated temperature sensor located in the thermal convection path is arranged radially internally in relation to the protective grid and in relation to associated heating element.

In some embodiments, the at least one heating element is spaced further apart axially in relation to the fixing surface than the respectively associated temperature sensor located in the thermal convection path. As a result, the temperature sensor is located in the thermally «upwardly» striving convection path of the ambient air heated directly by the adjacent heating element. As a result, improved detection of a rise in temperature is possible.

In some embodiments, the at least one inlet opening is arranged on a radially outer circumference of the housing.

In some embodiments, the fire detector has a constructive main axis, in particular an axis of symmetry. The fire detector has a fixing surface for at least detachable fixing of the fire detector to an assembly plane, in particular to a ceiling. An, in particular, central opening is arranged at an outer side of a basic body of the housing and is axially opposite in relation to the main axis of the fixing surface. The central opening has the protective grid. The at least one heating element is spaced further apart axially in relation to the fixing surface than the respectively associated temperature sensor located in the thermal convection path. The protective grid is arranged between the at least one heating element and the respective temperature sensor.

In some embodiments, a respective heating element is located directly axially opposite a respectively associated temperature sensor located in the thermal convection path. In this case, the respective temperature sensor is located directly in the convection path of an associated heating element located directly «underneath».

In some embodiments, the fire detector has a detector hood as part of the housing, which hood opposes the central opening. In relation to the main axis, the central opening extends outwards in the radial direction between the basic body and the detector hood. The central opening extending in this direction then forms the at least one inlet opening at a radial outer circumference of the housing.

In some embodiments, an optical measuring chamber according to the scattered light or extinction principle, and/or a danger sensor, in particular a gas sensor, for detecting the at least one fire characteristic is arranged in the interior of the housing. The control unit is configured or programmed to detect the respective detected temperature sensor signal as a further fire characteristic, to evaluate a respective fire sensor signal, output by the optical measuring chamber and/or by the danger sensor, together with the respective temperature sensor signal, and to then output the fire alarm in the event of a detected fire.

The evaluation can take place, for example, according to an AND/OR function. In some embodiments, it can take place in a weighted manner within the meaning of a multi-criteria detector. The gas sensor is, for example, a CO gas sensor, a CO2 gas sensor, a sensor which reacts to ammonia or to explosive gases.

In some embodiments, the control unit is configured to actuate the respective heating element repeatedly, in particular cyclically, with a measuring period for emission of the predetermined quantity of heat Q. The measuring period lies in a range of 15 minutes to 1 month, in a range of 1 hour to 1 week, or in a range of 12 hours to 48 hours.

The control unit is also configured to repeatedly detect, in particular cyclically within the measuring periods, an amplitude of a rise in temperature in the temperature sensor signal of the respectively associated temperature sensor and to output an alarm indication if, within the test period, at least one of the amplitudes of a rise in temperature remains below the comparison amplitude of a rise in temperature.

In some embodiments, the control unit can be configured to repeatedly detect, in particular cyclically within the measuring periods, an amplitude rise time in the temperature sensor signal of the respectively associated temperature sensor and to output an alarm indication if, within the test period, at least one of the amplitude rise times is greater than the rise time of a comparison amplitude.

In some embodiments, the control unit can be configured to repeatedly ascertain, in particular cyclically within the measuring periods, a time integral of the rise in temperature in the temperature signal of the respectively associated temperature sensor and to output an alarm indication if, within the test period, the value of the ascertained integral remains below the comparison integral value.

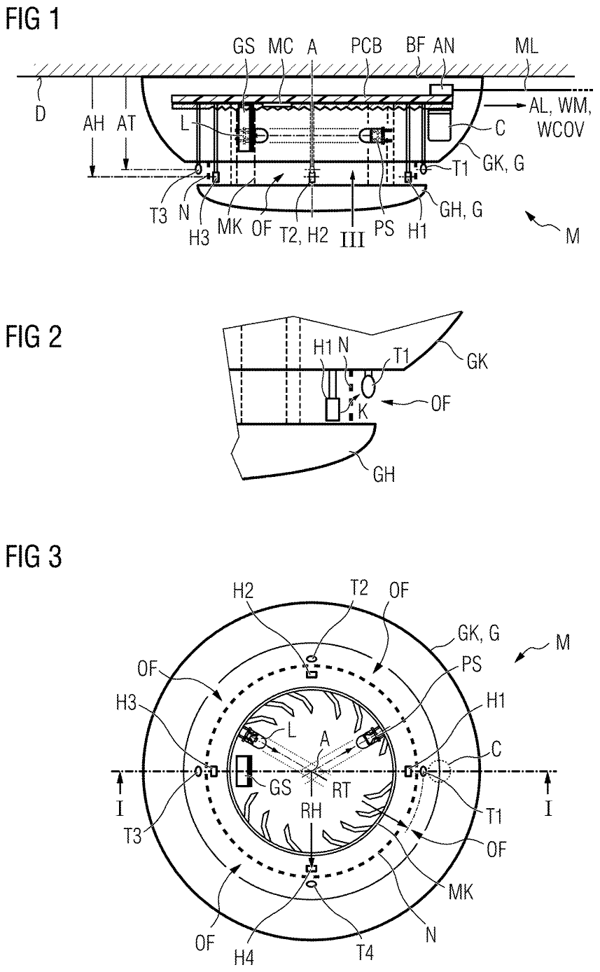

FIG. 1 shows a sectional representation through an example fire detector M incorporating teachings of the present disclosure with four heating elements H1-H4 and with four temperature sensors T1-T4. The fire detector M has a housing G, which is composed of a basic body GK and of a detector hood GH separated therefrom. There is a, in relation to the main axis A, circumferential inlet opening OF between the basic body GK and the detector hood GH. Smoke which is to be detected can reach the interior of the fire detector M or the measuring chamber MK there via this inlet opening OF. The fire detector M also comprises a constructive main axis A, in particular an axis of symmetry. A fixing surface BF is formed on the basic body GK of the fire detector M for fixing the fire detector M, typically to a ceiling D. An optical measuring chamber MK is received in the basic body GK, and for optical scattered light detection comprises, as is known, a light-emitting diode L as well as a photo sensor PS. The light-emitting diode L, the photo sensor PS as well as a danger sensor GS, such as a CO gas sensor, are arranged, together with a microcontroller MC as a control unit, on a circuit carrier PCB. The control unit MC is configured or programmed to inventively output a fire alarm AL in a detected case of fire and an alarm indication WM in the event of detected, impermissibly high contamination.

In the present example, four heating elements H1-H4 uniformly distributed in the circumferential direction are arranged in the region of the inlet opening OF. One temperature sensor T1-T4 is arranged [on] one heating element H1-H4 respectively at an identical circumferential position but offset thereto in the axial and radial directions. Arranged in the region of the inlet opening OF as well as firstly between the heating elements H1-H4 and secondly, the temperature sensors T1-T4 is a protective grid N, in particular for protection against insects and dust. As may also be seen in FIG. 1, the four heating elements H1-H4 are located radially internally in relation to the protective grid and the respective associated temperature sensor T1-T4, located or adjacent in the thermal convection path, radially externally in relation to the protective grid N (see also FIG. 3 in this regard).

In some embodiments, the heating elements H1-H4 are spaced further apart axially in relation to the fixing surface than the respectively associated, adjacent temperature sensors T1-T4. As a result, a temperature sensor T1-T4 is located in the thermally «upwardly» striving convection path K of the ambient air heated directly by an adjacent heating element H1-H4.

In the example of FIG. 1, an electrical energy store C in the form of a capacitor is arranged on the circuit carrier PCB. The electrical energy store C is provided for buffering electrical power provided via the detector line ML. The capacitor C may be a double-layer capacitor, such as what is known as a supercapacitor or an ultracapacitor («ultracap»). The electrical energy store C can also be a battery. The electrical energy store C can also be a parallel circuit comprising a capacitor C and a battery. The control unit MC is configured to repeatedly actuate the respective heating element H1-H4 with a specifiable heating duration HD for short-term emission of a predetermined quantity of heat Q when a sufficiently large, buffered quantity of electrical energy is loaded in the energy store C.

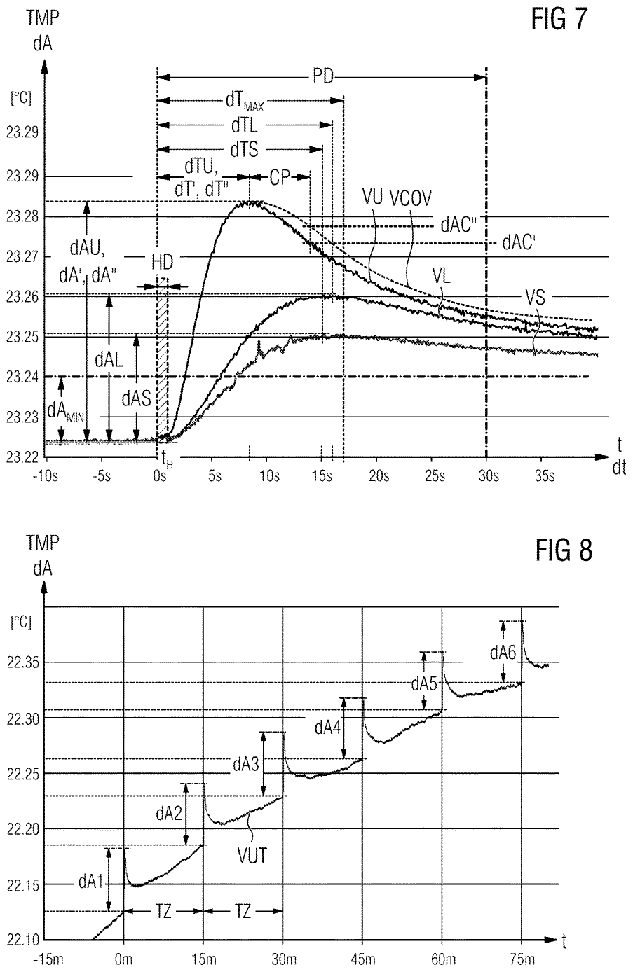

WCOV designates a covered indication, which is output by the control unit MC if, inventively, the difference in the detected amplitude of a rise in temperature dA′ and the detected amplitude of a test rise in temperature dAC′ is at least 1.05 times, at least 1.1 times or at least 1.2 times, as large as the difference in the re-detected amplitude of a rise in temperature dA″ and the re-detected amplitude of a test rise in temperature dAC″ (see FIG. 7 hereinafter in this regard).

FIG. 2 shows an enlarged representation of a heating element/temperature sensor pair H1, T1 according to the example in FIG. 1. It can be seen particularly clearly how the ambient air heated directly by the heating element H1, following the marked convection path K, reaches the thermally overlying temperature sensor T1 through the protective grid N.

FIG. 3 shows a plan view of the exemplary fire detector M according to FIG. 1. In this representation, apart from the arrangement for scattered light detection, comprising the light-emitting diode L and the photo sensor S, an annularly embodied protective grid N can be seen, which is arranged between the internal four heating elements H1-H4 and the four radially external temperature sensors T1-T4 in the radial direction in relation to the main axis A of the fire detector M. RH designates the radial spacing of the heating elements H1-H4 and RT the radial spacing of the temperature sensors T1-T4, in each case measured from the main axis A of the fire detector M. The arrangement shown enables sufficiently reliable all-round monitoring of the inlet opening OF in the circumferential direction.

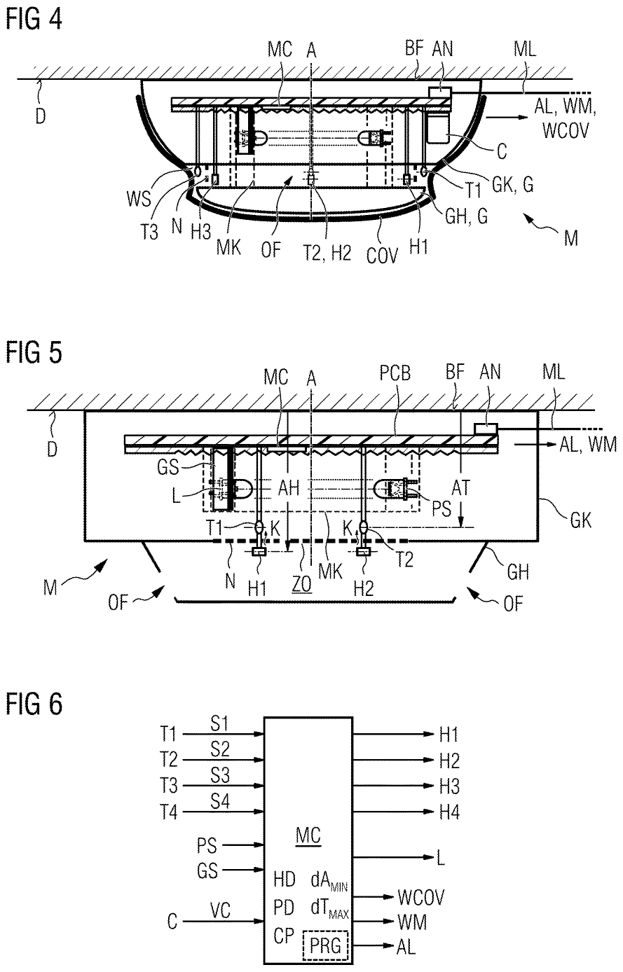

FIG. 4 shows the fire detector M shown in FIG. 1 with a cover COV mounted thereon, here in the form of a protective cap. Such a cover is used, for example, during painting or building work in order to prevent the fire detector M from accidentally being painted over or in order to prevent a false alarm. Masking of the inlet openings OF by means of adhesive tape is also known in order to prevent the fire detector M from being accidentally triggered, for example during building work that creates a lot of dust. As a result, a false alarm is prevented but removal of these adhesive tapes again is frequently overlooked. As a result, the fire detector M remains adversely unable to detect fire.

FIG. 4 also shows that a heat build-up region WS can form in the region between the temperature sensor T3 and the cover COV. After the short-term heating of the associated heating element H3 it is then not immediately possible for at least some of the heated ambient air, which has passed through the protective grid N, to escape through the left-hand inlet opening OF into the surroundings of the fire detector M. This delayed escape can be detected and evaluated by the respective temperature sensor T3. In the event of detection of such a build-up of heat, the control unit MC then outputs a corresponding covered indication WCOV, preferably to the detector line ML.

FIG. 5 a sectional representation through an exemplary fire detector M with a vertical arrangement of two heating element/temperature sensor pairs H1, T1; H2, T2. Compared to FIG. 1, the protective grid N covers an opening ZO, in particular as shown in the example of FIG. 5, a central opening, that is to say a centrally oriented opening ZO, or in relation to the main axis A of the fire detector M. In addition, the central opening ZO is arranged at an outer side, axially opposing the fixing surface BF, of a basic body GG of the housing G. The two heating elements H1, H2 shown by way of example are spaced further apart axially in relation to the fixing surface BF than the respectively associated temperature sensors T1, T2 located in the thermal convection path.

The two heating elements H1, H2 align with the associated temperature sensor T1, T2 in each case. The two temperature sensors T1, T2 are located directly in the convection flow of the ambient air heated by the two heating elements H1, H2, symbolized by two arrows designated K. In addition, the two heating elements H1, H2 and the two associated temperature sensors T1, T2 are arranged, by way of example, mirror-inverted to the main axis A, so different parts can be monitored in the region of the inlet opening OF and of the protective grid N for impermissibly high contamination.

In addition, in the example of FIG. 5, the fire detector M has a detector hood GH as part of the housing G. This may be necessary, for example, in order to additionally shield the central opening ZO against the penetration of ambient light into the optical measuring chamber MK. The detector hood GH axially opposes the central opening ZO. In relation to the main axis A, the central opening ZO extends outwards in the radial direction between the basic body GK and the detector hood GH and forms a circumferential inlet opening OF there in relation to the main axis A, at a radial outer circumference of the housing G of the fire detector M.

FIG. 6 shows an example control unit MC incorporating teachings of the present disclosure for the connection, inter alia, of four heating elements H1-H4 and four temperature sensors T1-T4. The control unit MC shown is, in particular, a processor-controlled control unit and typically a microcontroller. A processor unit (not shown) of the microcontroller MC is configured to execute a program PRG loaded in a memory of the microcontroller MC. The memory is preferably a non-volatile electronic memory, such as a flash memory. The microcontroller MC can have specific function blocks, moreover, which are already integrated as hardware functional units in the microcontroller MC, such as analog/digital converters, signal processors, digital inputs, digital outputs as well as bus interfaces.

In the example of the present FIG. 6, the schematically shown microcontroller MC has at the input side four analog/digital converters for metrological conversion of four detected temperature signals S1-S4 into corresponding digital values. The four temperature signals S1-S4 originate from the four temperature sensors T1-T4 in the fire detector M according to FIG. 1. Two further input-side analog/digital converters serve for metrological conversion of a signal output by the photo sensor PS and a signal output by the danger sensor GS of the fire detector M into corresponding digital values. Four digital outputs are provided for electric actuation of the four heating elements H1-H4, as well as three further for electric actuation of the light-emitting diode L, for outputting a fire alarm AL as well as for outputting an alarm W indication. Corresponding digital values for the heating duration HD, for the test period PD, for the comparison amplitude of a rise in temperature dAMIN as well as for the comparison rise time dTMAX are likewise stored in the non-volatile electronic memory of the microcontroller MC.

The microcontroller MC is configured, by means of the executed program PRG, to actuate the four heating elements H1-H4 for the specified heating duration HD to emit a predetermined quantity of heat Q and to output the alarm indication WM if, within the specified test period PD from emission of the predetermined quantity of heat Q, only a slight rise in temperature can be detected in the four temperature sensor signals S1-S4, which are output by the four temperature sensors T1-T4.

In some embodiments, the microcontroller MC can be configured by means of the executed program PRG, to detect an amplitude of a rise in temperature dA in the four temperature sensor signals S1-S4 and to output the alarm indication WM if at least one of the amplitudes of a rise in temperature dA remains below the specified comparison amplitude of a rise in temperature dAMIN.

In some embodiments, the microcontroller MC can be configured, by means of the executed program PRG, to detect an amplitude rise time dT in the four temperature sensor signals S1-S4 and to output the alarm indication WM if at least one of the amplitude rise times dT is greater than the specified rise time of a comparison amplitude dTMAX. Finally, the microcontroller MC can be configured, by means of the executed program PRG, to computationally ascertain a time integral of the rise in temperature in the four temperature signals S1-S4 and to output the alarm indication WM if the value of the ascertained integral remains below a specified comparison integral value.

In the example of FIG. 6, the control unit MC is also already configured to output a covered indication WCOV if the difference in the detected amplitude of a rise in temperature dA′ and the detected amplitude of a test rise in temperature dAC′ is at least 1.05 times, at least 1.1 times or at least 1.2 times, as large as the difference in the re-detected amplitude of a rise in temperature dA″ and the re-detected amplitude of a test rise in temperature dAC″ (see also FIG. 7 hereinafter in this regard). With CP, by way of example a covered test time electronically stored in the control unit MC, i.e. a test time for the presence of a cover, is stored. At the input side, VC designates an electrical voltage at the electrical energy store C. If this is sufficiently high, then, by means of the control unit MC, a next heating element H1-H4 can be actuated to detect impermissibly high contamination or an impermissible cover COV for emission of a quantity of heat Q.

FIG. 7 shows different measured temperature profiles VU, VL, VS and VCOV at a temperature sensor T1-T4 after emission of a quantity of heat Q and with contamination to differing degrees of a fire detector M during a test. The temperature TMP, detected by a temperature sensor (NTC), in the surroundings of the fire detector M is plotted in degrees Celsius over time t. The entire measurement extends over a period of approx. 60 seconds, in each case starting from a starting instant t_{H} at which a heating element (resistor) was subjected to an electrical power of 160 milliwatts for a heating duration HD of 1 second. Some of the quantity of heat Q, emitted by the resistor, in the form of a heated surge of air reaches the NTC only after a rise time dT and with different amplitude dA, depending on the degree of contamination of the protective grid N. For the present test, the protective grid N was provided with a thin layer and with a thicker layer of dust.

In general, the rise time dT and the amplitude dA depend on the emitted quantity of heat Q, on the heating duration PD, on the convection conditions, on the spacings of the heating element H1-H4, the protective grid N and temperature sensor T1-T4 among themselves as well as on the qualities and on the degree of contamination of the inlet opening as well as of the protective grid N.

A measured temperature profile VU in the uncontaminated state of the protective grid N, a measured temperature profile VL in the slightly contaminated state of the protective grid N and a measured temperature profile VS in the severely contaminated state of the protective grid N are represented. In addition, the associated amplitudes of a rise in temperature dAU, dAL, dAS as well as the associated rise times dTU, dTL, dTS, in each case for the uncontaminated, slightly contaminated and severely contaminated states of the protective grid N, are plotted. PD designates a test period within which a rise in temperature is metrologically evaluated for whether an impermissibly high level of contamination of the protective grid N exists or not.

As FIG. 7 shows, the slight contamination of the protective grid N causes a significant reduction in the amplitude dA by approx. 40% compared to the uncontaminated protective grid N, with a simultaneous increase in the rise time dT by approx. 85%. In contrast to this, the severe contamination of the protective grid N causes a significant reduction in the amplitude dA by approx. 55% compared to the uncontaminated protective grid N with an increase in the rise time dT by approx. 85%. The significant reduction in the amplitude dA as well as the significant increase in the rise time dT of a contaminated protective grid compared to an uncontaminated protective grid N advantageously allow reliable detection of contamination of the protective grid N and/or the region of the inlet opening OF in which the protective grid N is arranged.

The degree of contamination, at which an alarm W should be output, is set by fixing appropriate specifiable comparison thresholds. In the example of FIG. 7 at hand, the comparison amplitude of a rise in temperature dAMIN is fixed at a value of 25% in relation to the amplitude of a rise in temperature dAU of the uncontaminated protective grid N. As an alternative comparison criterion, the comparison rise time dTMAX is fixed to twice the value of the rise time dTU of the uncontaminated protective grid N.

A temperature profile VCOV, represented in broken lines, can also be seen in FIG. 7 for the uncontaminated but covered case of a fire detector M with the protective cap COV shown in FIG. 4. Here the temperature profile VCOV is greater compared to the temperature profile VU—here, by way of example, for the uncontaminated and uncovered fire detector M. In the present example, both temperature profiles VCOV, VU show an approximately identical amplitude of a rise in temperature dA′, dA″ with an approximately identical amplitude rise time dT′, dT″. However, identical amplitudes of a rise in temperature dA′, dA″ and identical amplitude rise times dT′, dT″ are not always given and substantially depend on the continuously changing ambient temperature TMP in the region of the fire detector M.

As FIG. 7 also shows, the detected temperature values in the temperature profile VCOV for the uncontaminated, but covered, case of the fire detector M from the detected amplitude of a rise in temperature dA″, i.e. the detected maximum temperature value, lie above the temperature values in the temperature profile VU of the uncontaminated and uncovered fire detector M. This difference is due to a heat build-up between the cover COV and the temperature sensor, whose detected temperature signal can be seen in the temperature profile VCO, with the heat build-up slowing down cooling of the heated ambient air around the temperature sensor and thus showing increased temperature values in the temperature profile VOC. CP designates a specified covered test time of about 6 seconds, after the expiry of which the corresponding amplitudes of a test rise in temperature dAC′, dAC″ are detected.

An alarm indication WM and/or a covered indication WCOV is then output if the difference in the detected amplitude of a rise in temperature dA′ and the detected amplitude of a test rise in temperature dAC′ is at least 1.05 times, at least 1.1 times or at least 1.2 times, as large as the difference in the re-detected amplitude of a rise in temperature dA″ and the re-detected amplitude of a test rise in temperature dAC″. Here, the test comparative value is thus 1.05, 1.1 or 1.2, therefore.

In the present case, the difference in the detected amplitude of a rise in temperature dA′ and the detected amplitude of a test rise in temperature dAC′ is 1.08 times as large as the difference in the re-detected amplitude of a rise in temperature dA″ and the re-detected amplitude of a test rise in temperature dAC″. An alarm indication WM and/or a covered indication WCOV would then output by the control unit MC if the test comparative value is fixed at 1.05.

The previously detected amplitude rise times dT′, dT″, the amplitudes of a rise in temperature dA′, dA″, the amplitudes of a test temperature rise dAC′, dAC″ as well as the previously mentioned test comparative value can also be (temporarily) stored in non-volatile memories.

In some embodiments, the control unit MC can be configured to not output an alarm indication WM and/or a covered indication WCOV immediately, rather only when the test comparative value is exceeded several times in succession, for example twice, three times or four times.

Finally, FIG. 8 shows a temperature profile VUT at a temperature sensor in the case of cyclical emission of a quantity of heat Q with a measuring period TZ, overlaid by an increasing ambient temperature. Slight temperature gradients, as customarily exist in the surroundings of a fire detector, can be compensated by means of a suitable program, which is loaded on a microcontroller. As FIG. 8 shows, the respective amplitudes of a rise in temperature dA1-dA6 are almost identical and thus largely independent of the current ambient temperature of the fire detector at approx. 22 °C.

The present disclosure describes various fire detectors for detecting a fire characteristic as well as for outputting a fire alarm. An example comprises a housing G with at least one inlet opening OF, wherein, in the region thereof, a penetrable protective grid N, as well as sensor system for detecting contamination there, is arranged. The fire detector M comprises a control unit MC, connected to the sensor system, for outputting an alarm indication WM when contamination is detected. The sensor system comprises at least one heating element H1-H4, which can be actuated by the control unit MC, as well as a temperature sensor T1-T4, associated with the respective heating element H1-H4 and connected to the control unit MC, for outputting a temperature sensor signal S1-S4. The protective grid N is arranged between heating element H1-H4 and the temperature sensor T1-T4 located in the thermal convection path of the heating element H1-H4. The fire detector M comprises an electrical energy store C for buffering electrical power provided via the detector line ML. The control unit MC is configured to repeatedly actuate the heating element H1-H4 with a heating duration HD for emission of a predetermined quantity of heat Q if a sufficiently large, buffered quantity of electrical energy is loaded in the energy store C.

### LIST OF REFERENCE NUMERALS

A constructive main axis, axis of symmetry
AH axial spacing from a heating element
AL alarm, fire alarm
AN connection to the detector line
AT axial spacing from a temperature sensor
BF fixing surface
C electrical energy store, capacitor, battery
COV cover, protective hood, adhesive tape
CP covered test time, test time for presence of a cover
D assembly plane, ceiling
dA, dA′, dA″ amplitude of a rise in temperature
dAC′, dAC″ amplitude of a test rise in temperature
dA1-dA6 amplitudes of a rise in temperature
dAL amplitude of a rise in temperature in the slightly contaminated state
dAMIN comparison amplitude of a rise in temperature
dAS amplitude of a rise in temperature in the severely contaminated state
dAU amplitude of a rise in temperature in the uncontaminated state dAC
dT, dT′, dT″ rise time
dTL rise time in the slightly contaminated state
dTMAX comparison rise time
dTS rise time in the severely contaminated state
dTU rise time in the uncontaminated state
G housing
GH detector hood
GK basic body
GS danger sensor, gas sensor, CO sensor
H1-H4 heating element, ohmic resistor, Zener diode
HD heating duration
TP convection path, thermal path
L light emitter, light-emitting diode, LED
M fire detector, smoke detector
MC control unit, microcontroller
MK measuring chamber, optical measuring chamber, labyrinth
ML detector line, detector bus
N protective grid, mesh
OF inlet opening, smoke inlet opening
PCB circuit carrier, printed circuit board
PD test period
PRG program
PS photo sensor, photodiode
RH radial spacing from a heating element
RT radial spacing from a temperature sensor
S1-S4 sensor signal
T1-T4 temperature sensor, thermistor, NTC
VUT profile of the ambient temperature
TMP temperature
t time, time axis
t_{H} heating starting point
TZ measuring period
VC voltage at the energy store, capacitor voltage
VCOV temperature profile with mounted cover, by way of example in the uncontaminated state
VL temperature profile in the slightly contaminated state
VS temperature profile in the severely contaminated state
VU temperature profile in the uncontaminated state
VUT profile of the ambient temperature
WCOV covered indication
WM alarm indication
WS heat build-up region, heat cushion
ZO central opening

1. A fire detector for detecting at least one fire characteristic and generating a fire alarm (AL) in a detected case of fire, the fire detector comprising:
a power inlet to supply of the fire detector with electrical power via a detector line of a fire detection system;
a housing with an inlet opening;
a penetrable protective grid arranged over the inlet opening;
a sensor system arranged within the housing approximate the inlet opening for detecting contamination;
a control unit communicatively connected to the sensor system, the control unit configured to generate an alarm indication in event of contamination above a threshold;
wherein the sensor system has a heating element operable by the control unit and a temperature sensor associated with the heating element and connected to the control unit to deliver a temperature sensor signal;
wherein the protective grid is arranged between the heating element and the temperature sensor;
wherein the temperature sensor is arranged in the thermal convection path of the heating element;
an electrical energy store for buffering electrical power provided via the detector line;
wherein the control unit is configured to repeatedly actuate the heating element with a specifiable heating duration for short-term emission of a predetermined quantity of heat Q if a sufficiently large, buffered quantity of electrical energy is loaded in the energy store and coordinated therewith, to repeatedly:
detect an amplitude of a rise in temperature in the temperature sensor signal and to generate an alarm indication if, within a specified test period from emission of the predetermined quantity of heat Q, the amplitude remains below a specified comparison amplitude; and/or
detect an amplitude rise time in the temperature sensor signal and generate an alarm indication if, within a specified test period from emission of the predetermined quantity of heat Q, the amplitude rise time is greater than a specified rise time of a comparison amplitude; and/or
ascertain a time integral of the rise in temperature in the temperature signal and generate an alarm indication if, within a specified test period from emission of the quantity of heat Q, the value of the ascertained integral remains below a specified comparison integral value.

2. The fire detector as claimed in claim 1, wherein the control unit is configured to actuate the heating element to emit a quantity of heat Q in the range of 10 mJ to 5 Joules with a heating duration in the range of 1 second to 30 seconds.

3. The fire detector as claimed in claim 1, wherein the heating element and/or the temperature sensor has a thermal time constant in the range of 0.5 to 10 seconds.

4. The fire detector as claimed in claim 3, wherein:
an amplitude of a rise in temperature in the uncontaminated state of the fire detector lies in the range of 20 mK to 1,000 mK; or
the specified comparison amplitude of a rise in temperature lies in the range of 0.1 to 0.8 times.

5. The fire detector as claimed in claim 3, wherein:
the specified rise time of a comparison amplitude has a value in a range of 5 seconds to 25 seconds; or
the specified rise time of a comparison amplitude has a value which lies in a range of 1.2 to 3 times an amplitude rise time in the uncontaminated state of the fire detector.

6. The fire detector as claimed in claim 3, wherein:
the control unit is configured to ascertain the time integral of the rise in temperature in the temperature signal;
and the specified comparison integral value lies in a range of 0.1 to 0.8 times the time integral value in the uncontaminated state of the fire detector.

7. The fire detector as claimed in claim 3, wherein the respective amplitude of a rise in temperature, the respective amplitude rise time, and/or the respective time integral value is computationally formed from a sliding mean of a plurality of respectively repeatedly detected amplitudes of a rise in temperature, amplitude rise times, or time integral values.

8. The fire detector as claimed in claim 1, wherein:
the fire detector has a constructive main axis;
the fire detector includes a fixing surface for fixing of the fire detector to an assembly plane;
multiple inlet openings are radially spaced part in relation to the main axis;
the heating element is arranged radially internally in relation to the protective grid; and
the respective associated temperature sensor is arranged radially externally in relation to the protective grid and to the heating element.

9. The fire detector as claimed in claim 8, wherein the control unit is configured to
detect an amplitude rise time in the temperature sensor signal, a respective associated amplitude of a rise in temperature, and a respective associated amplitude of a test rise in temperature after expiry of a specified covered test time from the instant of the detected amplitude rise time;
re-detect, at least on the next repetition, an amplitude rise time in the temperature sensor signal, re-detect a respective associated amplitude of a rise in temperature, and re-detect a respective associated amplitude of a test rise in temperature after expiry of the covered test time from the instant of the re-detected amplitude rise time; and
generate an alarm indication and/or a covered indication if the difference in the detected amplitude of a rise in temperature and the detected amplitude of a test rise in temperature is at least 1.05 times as large as the difference in the re-detected amplitude of a rise in temperature and the re-detected amplitude of a test rise in temperature.

10. The fire detector as claimed in claim 9, wherein the covered test time has a value in a range of 1 second to 30 seconds.

11. The fire detector as claimed in claim 1, wherein:
the fire detector has a constructive main axis;
the fire detector has a fixing surface for fixing of the fire detector to an assembly plane;
multiple inlet openings are radially spaced part in relation to the main axis;
the heating element is arranged radially externally in relation to the protective grid;
the temperature sensor is arranged radially internally in relation to the protective grid and in relation to the heating element.

12. The fire detector as claimed in claim 1, wherein:
the fire detector has a constructive main axis;
the fire detector has a fixing surface for fixing the fire detector to an assembly plane;
a central opening is arranged at an outer side axially opposite in relation to the main axis of the fixing surface of a basic body of the housing;
the central opening has the protective grid
the heating element is spaced further apart axially in relation to the fixing surface than the temperature sensor; and
the protective grid is arranged between the heating element and the temperature sensor.

13. The fire detector as claimed in claim 12, wherein:
the fire detector has a detector hood which opposes the central opening; and
in relation to the main axis, the central opening extends outwardly in the radial direction between the basic body and the detector hood and forms the inlet opening at a radial outer circumference of the housing.

14. The fire detector as claimed in claim 1, further comprising an optical measuring chamber and/or a gas sensor for detecting the fire characteristic;
wherein the control unit is configured to detect the temperature sensor signal as a further fire characteristic, to evaluate a respective fire sensor signal, generated by the optical measuring chamber and/or by the gas sensor, together with the temperature sensor signal and in the event of a detected case of fire, to generate the alarm.

15. The fire detector as claimed in claim 1, wherein:
the control unit is configured to repeatedly actuate the heating element for emission of the predetermined quantity of heat Q;
the measuring period lies in a range of 15 minutes to 1 month; and
the control unit is configured to repeatedly within the measuring periods:
detect an amplitude of a rise in temperature in the temperature sensor signal and generate an alarm indication if, within the test period, at least one of the amplitudes of a rise in temperature remains below the comparison amplitude of a rise in temperature, and/or
detect an amplitude rise time in the temperature sensor signal and generate an alarm indication if, within the test period, at least one of the amplitude rise times dT is greater than the rise time of a comparison amplitude, and/or
ascertain a time integral of the rise in temperature in the temperature signal and generate an alarm indication if, within the test period, the value of the ascertained integral remains below the comparison integral value.
